(19) United States
(12) Patent Application Publication
(10) Pub. No.: US 2015/0031323 A1
(43) Pub. Date: Jan. 29, 2015

(54) APPARATUS AND METHOD TO IMPLEMENT A QUEUING PROCESS BY A POSITION ENABLED MOBILE DEVICE TO PRIORITIZE THE LEGITIMACY OF INITIATION MESSAGES FROM EMERGENCY LOCATION PLATFORMS

(71) Applicant: QUALCOMM Incorporated, San Diego, CA (US)

(72) Inventors: Philip Michael HAWKES, Warimoo (AU); Andreas Klaus WACHTER, Menlo Park, CA (US); Ning SHANG, San Diego, CA (US)

(73) Assignee: QUALCOMM Incorporated, San Diego, CA (US)

(21) Appl. No.: 13/948,985

(22) Filed: Jul. 23, 2013

(51) Int. Cl. H04W 4/22

(52) U.S. Cl. CPC H04W 4/22
USPC 455/404.2

(57) ABSTRACT

Disclosed is an apparatus and method to implement a queuing process by a position enabled mobile device to prioritize the legitimacy of initiation messages. The method may include: transmitting an emergency call; receiving at least one initiation message; and assigning the received initiation message to one of a plurality of priority queues, wherein the assignment to the priority queue is based upon at least one of an identifier of an emergency location platform or a whitelist.

### BACKGROUND

1. Field

The present invention relates to an apparatus and method to implement a queuing process by a position enabled mobile device to prioritize the legitimacy of initiation messages from emergency location platforms.

2. Relevant Background

Advances in technology have resulted in smaller and more powerful computing devices. For example, there currently exists a variety of portable personal computing devices, including wireless computing devices, such as portable wireless telephones, personal digital assistants (PDAs), and paging devices that are small, lightweight, and easily carried by users. More specifically, portable wireless telephones or mobile devices, such as cellular telephones and Internet Protocol (IP) telephones, can communicate voice and data packets over wireless networks. Further, many such wireless mobile devices include other types of devices that are incorporated therein. For example, a wireless mobile device can also include a digital still camera, a digital video camera, a digital recorder, and an audio file player.

A wireless mobile device may also be equipped with location determination hardware/software to enable location-based services. For example, the wireless mobile device may include a global positioning system (GPS) transceiver. The wireless mobile device may also receive network-assisted positioning information (e.g., positioning information based upon triangulating the wireless mobile device's location between multiple network towers).

Secure user plane location (SUPL) is a technology standard that may be used to enable location-based services for wireless devices in wireless communication systems. SUPL architecture may include two components: a SUPL enabled terminal (SET) (e.g., a wireless mobile device or telephone) and a SUPL location platform (SLP) that may be implemented as a network-accessible server.

The OMA SUPL (Open Mobile Alliance Secure User Plane Location) specification sets forth Emergency SUPL Location Platforms (E-SLPs) to interact with SUPL Enabled Terminals (SETs) in order to assist locating users in emergency call situations that have a SET device (e.g., a user having a wireless mobile device that is a SET device).

In particular, an E-SLP call flow has been introduced that works as follows: 1) The user using the SET calls an appropriate emergency number for the region in which the user is currently located. This action puts the SET into an “emergency mode” in which the SET will accept incoming “Emergency SUPL INIT” messages which may be delivered via MT SMS, SIP PUSH, OMA PUSH, or UDP/IP; 2) The emergency call is answered by a Public Safety Answering Point (PSAP); 3) The PSAP contacts an E-SLP to request a position estimate of the SET; 4) The E-SLP sends a “SUPL INIT” message to the SET that includes a FQDN (Fully-Qualified Domain Name) of the E-SLP and a SUPL session identifier; 5) The SET applies security processing to the incoming SUPL INITs; 6) The SET establishes a secure TLS connection to E-SLP using the FQDN in the SUPL INIT message. As part of the TLS handshake, the E-SLP authenticates itself by a certificate with a chain back to a root certificate pre-provisioned on the SET; 7) The SET and E-SLP start a SUPL session providing the SUPL session identifier as verification of the SET's identity; 8) The SET and E-SLP exchange messages in the course of which the position of the SET is determined; 9) The E-SLP returns the position estimate of the SET to the PSAP.

The OMA SUPL specification acknowledged the threat of one or more adversaries sending fake SUPL INIT messages to the SET at the time of an emergency—which could result in the SET performing a SUPL session with a fake E-SLP. In order to address this threat, the OMA SUPL specification proposed the use of an “E-SLP whitelist”. The E-SLP whitelist is described as containing a list of “pre-approved” E-SLP FQDN that would be pre-configured and maintained on the SET.

However, this solution requires that public safety organizations (or some other organizations) assume the role of collecting, disseminating, and updating the E-SLP white-list. Unfortunately, no organization has implemented this role nor do any appear willing or able to do so. Consequently, it is not possible to definitively rely on an E-SLP whitelist. Further, there are many inconsistencies in the use of the E-SLP whitelist as proposed by the OMA SUPL specification.

Accordingly, methods for relying on legitimate E-SLPs are sought after.

### SUMMARY

Aspects of the invention may relate to an apparatus and method to implement a queuing process by a position enabled mobile device to prioritize the legitimacy of initiation messages. The method may include: transmitting an emergency call; receiving at least one initiation message; and assigning the received initiation message to one of a plurality of priority queues, wherein the assignment to the priority queue is based upon at least one of an identifier of an emergency location platform or a whitelist.

### BRIEF DESCRIPTION OF THE DRAWINGS

FIG. 1 is a diagram of a system in which aspects of the invention related to a mobile device that implements a queuing process to prioritize the legitimacy of initiation messages from emergency location platforms may be practiced.

FIG. 2 is a flow diagram illustrating an example of a process to implement a queuing process by a position enabled mobile device.

FIG. 3 is a flow diagram illustrating a more detailed example of a process to implement a queuing process by a position enabled mobile device.

FIG. 4 is a flow diagram illustrating an example of a queuing process to utilize priority queues.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

Embodiments of the invention relate to providing a methodology to utilize a queuing system by a position enabled mobile device to allow the position enabled mobile device to prioritize the legitimacy of initiation messages in order to determine a valid emergency location platform.

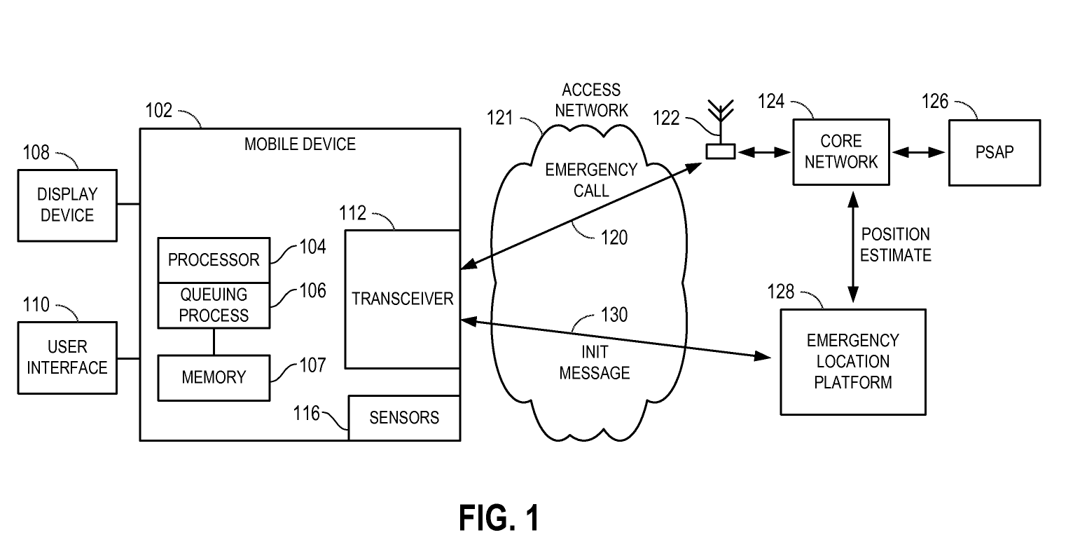

With reference to FIG. 1, an example of an environment and a position enabled mobile device 102, in which embodiments of the invention may be practiced, is illustrated. As an example, a position enabled mobile device 102 may transmit an emergency call 120 to a public safety answering point (PSAP) 126. The PSAP 126 may contact an emergency location platform 128 to request a position estimate of the mobile device. Further, the mobile device 102 may receive one or more initiation messages 130 from one or more emergency location platforms 128 to determine the location of the mobile device 102.

The position enabled mobile device 102, under the control of processor 104, implementing a queuing process 106, may assign received initiation messages 130 to one of a plurality of different priority queues, wherein the assignment to the priority queue is based upon at least one of an identifier of an emergency location platform or a whitelist. In one embodiment, the identifier of the emergency location platform is a domain name (DN). Based upon this, the position enabled mobile device 102 can prioritize the legitimacy of initiation messages 130 in order to determine a valid emergency location platform 128 such that a valid emergency location platform provides a valid position estimate of the mobile device to the PSAP 126. The details of these techniques will be described in more detail hereinafter.

In one embodiment, position enabled mobile device 102 may include a processor 104 that implements queuing process 106, a memory 107, a display device 108, a user interface 110, a network interface (I/F) transceiver 112, and sensors 116. Processor 104 may be configured to execute operations to be hereinafter described. Particularly, processor 104 may implement the queuing process 106 to assign received initiation messages 130 to one of a plurality of different priority queues, wherein the assignment to the priority queue is based upon at least one of a identifier of an emergency location platform (e.g., a domain name (DN)) or a whitelist, as will be described in more detail hereinafter. Memory 107 may store operations, applications, programs, routines, etc., to aid in implementing these operations and functions.

Position enabled mobile device 102 may include common device features such as a display device 108, a user interface 110 (e.g., a keyboard, a keypad, touch screen input, etc.), and a network interface (I/F) transceiver 112. Mobile device 102 may be any type of computing device that has wireless capability, such as: mobile devices, wireless devices, personal digital assistants, wireless phones, cell phones, smart phones, tablets, machine-to-machine (M2M) devices, personal computers, desktop computers, laptop computers, mobile computers, or any type of computing device that includes wireless capabilities.

Position enabled mobile device 102 may include a variety of different types of interface transceivers 112 for wireless communication through a wireless access network 121 (e.g., cellular networks, WLANs, WiFi networks, etc.). As examples, mobile device 102 may include a cellular transceiver 112 (e.g., including a transmitter and receiver) that may communicate signals through a cellular access network 121 to a base station 122, through a core network 124, and to PSAP 126. Such communication signals may include voice communications as well as digital data communications. PSAP 126 may communicate with the emergency location platform 128 through an appropriate network 124. Furthermore, emergency location platform 128 and mobile device 102 may be in communication through the access network 121. Examples of these signals include emergency calls 120 and INIT messages 130. It should be appreciated that wireless communication signals to and from mobile device 102 can be received and consolidated through the access network 121, through base stations 122, and through resources located through the core network 124. Resources that support a wide variety of wireless communication services can include servers for voice mail and email managed by wireless communication service providers (e.g., operator servers). Other resources can include public data servers available for access through the Internet and private data servers available for limited access through an enterprise network, etc.

Further, position enabled mobile device 102 may include sensors 116 including proximity sensors, motion sensors, accelerometer sensors, position sensors, location sensors, pressure sensors, microphones, cameras, sound sensors, light sensors, etc., to implement various features commonly associated with mobile devices 102.

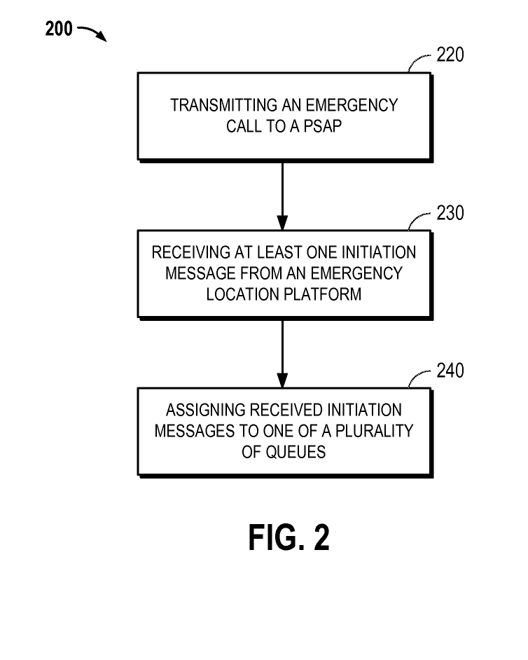

In one embodiment, with additional reference to FIG. 2, the position enabled mobile device 102, under the control of processor 104, may transmit an emergency call 120 through access network 121 to a public safety answering point (PSAP) 126 (block 220). The mobile device 102 may receive one or more initiation messages 130 from one or more emergency location platforms 128 (block 230). The position enabled mobile device 102, under the control of processor 104, implementing a queuing process 106, may assign received initiation messages 130 to one of a plurality of different priority queues, wherein the assignment to the priority queue is based upon at least one of an identifier of an emergency location platform (e.g., a domain name (DN)) or a whitelist (block 240).

Looking at one embodiment, with particular reference to FIG. 1, in order to enable location-based services in wireless communication systems, the secure user plane location (SUPL) technology standard may be utilized. The SUPL architecture may include two components: a SUPL enabled terminal (SET) mobile device 102 (hereinafter also referred to as SET mobile device 102) and a SUPL location platform (SLP) that may be implemented as a network-accessible server (hereinafter also referred to as Emergency SLP (E-SLP) 128)).

In this example embodiment, an E-SLP call flow may work as follows. First, the user using the SET mobile device 102 places an appropriate emergency call 120 to an appropriate emergency number for the region in which the user is currently located. This action puts the SET mobile device 102 into an “emergency mode” in which the SET mobile device 102 may accept incoming Emergency SUPL INIT messages 130, which may be delivered via MT SMS, SIP PUSH, OMA PUSH, or UDP/IP. Second, the emergency call 120 is answered by a Public Safety Answering Point (PSAP) 126. Third, the PSAP 126 contacts an E-SLP 128 to request a position estimate of the SET mobile device 102. Fourth, The E-SLP 128 sends a “SUPL INIT” message 130 to the SET mobile device 102 that includes a FQDN (Fully-Qualified Domain Name) of the E-SLP 128 and a SUPL session identifier. Fifth, the SET mobile device 102 applies security processing to the incoming SUPL INIT message 130. Sixth, the SET mobile device 102 establishes a secure TLS connection to the E-SLP 128 using the FQDN in the SUPL INIT message. As part of the TLS handshake, the E-SLP 128 authenticates itself by a certificate with a chain back to a root certificate pre-provisioned on the SET mobile device 102. Seventh, SET mobile device 102 and the E-SLP 128 start a SUPL session with the SET mobile device 102 providing the SUPL session identifier as verification of the SET mobile device's identity. Eighth, SET mobile device 102 and the E-SLP 128 exchange messages in the course of which the position of the SET is determined. Lastly, The E-SLP 128 returns the position estimate of the SET mobile device 102 to the PSAP 126.

Unfortunately, adversaries could send fake SUPL INIT messages to the SET mobile device 102 at the time of an emergency—which could result in the SET mobile device 102 performing a SUPL session with a fake E-SLP. According to one embodiment, the SET mobile device 102, under the control of processor 104, implements a queuing process 106, to assign received initiation messages 130 to one of a plurality of different priority queues, wherein the assignment to the priority queue is based upon at least one of an identifier of an emergency location platform (e.g., a domain name (DN)) or a whitelist. Based upon this, the SET mobile device 102 can prioritize the legitimacy of initiation messages 130 in order to determine a valid emergency location platform (e.g., E-SLP 128) such that a valid E-SLP provides a valid position estimate of the mobile device to the PSAP 126. The details of these techniques will be described in more detail hereinafter.

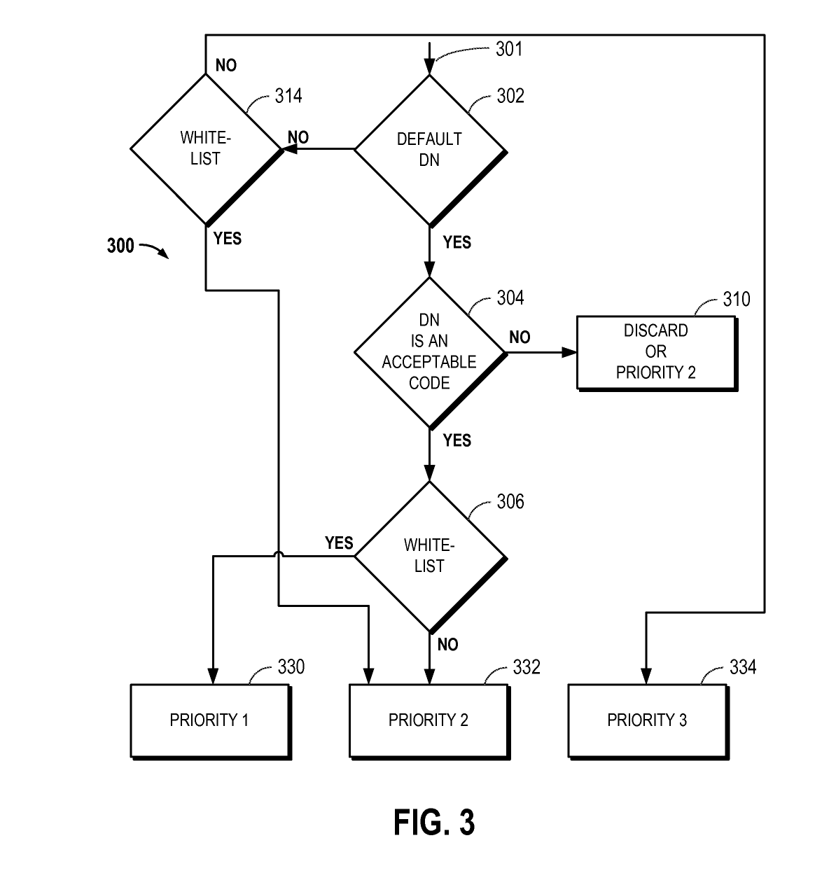

In one embodiment, with reference to FIG. 3, the queuing process 300 is implemented by the position enabled mobile device 102 to prioritize the legitimacy of initiation messages 130. As previously described, an emergency call 120 from the position enabled mobile device 102 is transmitted to the PSAP 126. The position enabled mobile device 102 receives at least one initiation message from at least one emergency location platform 128. The position enabled mobile device 102 assigns the received initiation messages 130 to one of a plurality of priority queues (e.g., first priority queue 330, second priority queue 332, and third priority queue 334), wherein the assignment to the priority queue is based upon at least one of an identifier of an emergency location platform (e.g., a domain name (DN)) of the initiation message or a whitelist of the initiation message. Further, as will be used hereinafter, the term acceptable code may be a prior code that was used in a previous predetermined period of time.

At line 301, the process starts. In particular, if the DN of the initiation message: at decision block 302 is in a default format; at decision block 304 is an acceptable code (e.g., a Mobile Network Code/Mobile Country Code (MNC/MCC)); and, at decision block 306 is in the whitelist—then the initiation message is added to the first priority queue 330. In another example, if the DN of the initiation message: at decision block 302 is in a default format; at decision block 304 is an acceptable code; and, at decision block 306 is not in the whitelist—then the initiation message is added to the second priority queue 332.

Further, if the DN of the initiation message: at decision block 302 is in a default format; but at decision block 304 is not an acceptable code—then at block 310 the initiation message is discarded. Alternatively, at block 310, the initiation message may be added to the second priority queue 332. Moreover, if the DN of the initiation message: at decision block 302 is not in a default format; and at decision block 314 is not in the whitelist—then the initiation message is added to the third priority queue 334. Alternatively, at decision block 314, if the DN is in the whitelist—then the initiation message is added to the second priority queue 332. More particulars of these examples will be hereinafter described.

As previously described, the position enabled mobile device 102 (e.g., a SET mobile device) may assign each incoming initiation message 130 (e.g., a SUPL INIT message) to one of three priority queues (e.g., Priority 1 queue 330, Priority 2 queue 332, and Priority 3 queue 334) based upon a fully-qualified domain name (FQDN) in the SUPL INIT message and/or its recognition in a whitelist. For example, a FQDN of an E-SLP 128 shall be provided to the SET mobile device 102 as an E-SLP address in the SUPL INIT message 130. The E-SLP FQDN may have the following example formats. If the mobile device is connected via a 3GPP network (e.g., GSM, WCDMA, LTE): e-slp.mnc<MNC>.mcc<MCC>.pub.3gppnetwork.org. If the mobile device is connected via a 3GPP2 network (e.g., CDMA, HRPD): e-slp.mnc<MNC>.mcc<MCC>.pub.3gpp2network.org

As a particular example, if the FQDN is in a particular pre-set default FQDN format (decision block 302), and the FQDN agrees with a Mobile Network Code/Mobile Country Code (MNC/MCC) used in the last X seconds (decision block 304), and the FQDN is in the whitelist (decision block 306), then the SUPL INIT message is added to the Priority 1 queue 330. On the other hand, if the FQDN is in a default FQDN format (decision block 302), and the FQDN agrees with an MNC/MCC used in the last X seconds (decision block 304), but the FQDN is not in the whitelist (decision block 306), then the SUPL INIT message is added to the Priority 2 queue 332.

Further, if the FQDN is in a default FQDN format (decision block 302), and the FQDN disagrees with an MNC/MCC used in the last X seconds (decision block 304), then two options may be used: Option 1—the SUPL INIT message is DISCARDED; or Option 2—the SUPL INIT message is added to the Priority 2 queue 332 (block 310). Moreover, if the FQDN is not in default FQDN format (decision block 302), but the FQDN is in the whitelist (decision block 314), then the SUPL INIT message is added to the Priority 2 queue 332. Otherwise, the SUPL INIT message is added to the Priority 3 queue 334.

Based upon the above-methodology, the SET mobile device 102 may prioritize the SUPL INIT messages 130 in order to select the SUPL INIT message (if multiple ones are received) that is likely to be legitimate and rely upon a valid E-SLP 128 such that proper position estimate information is determined, and, in particular, such that a valid E-SLP 128 provides a valid position estimate of the mobile device to the PSAP 126.

It should be appreciated that aspects of this methodology assumes that preferences are assigned in the cases where the FQDN is in the E-SLP whitelist, in cases where the particular pre-set default format FQDN is used, and in cases where the FQDN agrees with an MNC/MCC used in the last X seconds. Accordingly, based on these methodologies, SUPL INIT messages may be prioritized as: Priority 1, Priority 2, and Priority 3.

As previously described, the position enabled mobile device 102 (e.g., a SET mobile device) may assign each incoming initiation message 130 (e.g., a SUPL INIT message) to one of three priority queues (e.g., Priority 1 queue 330, Priority 2 queue 332, and Priority 3 queue 334) based upon a fully-qualified domain name (FQDN) in the SUPL INIT and/or its recognition in a whitelist.

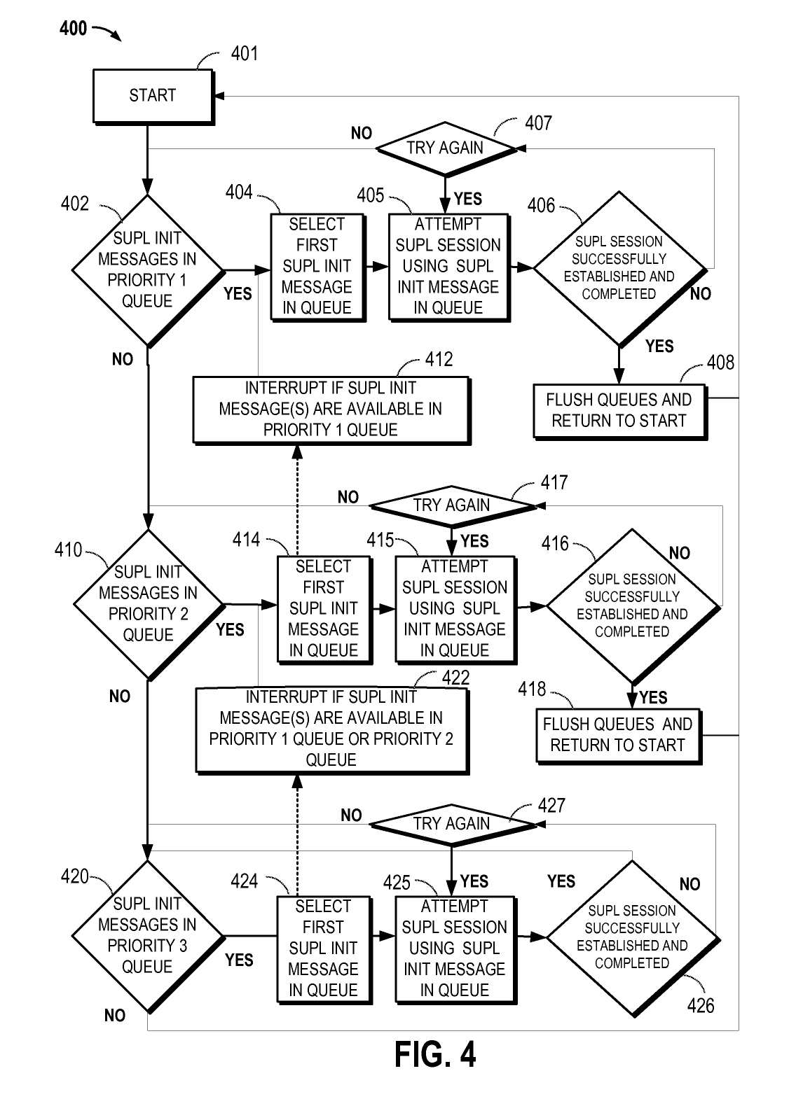

With reference to FIG. 4, a queuing process 400 is described to implement the usage of the priority queues during the emergency call context. In particular, after the emergency call has been made and the functions as described in FIG. 2 have been performed, process 400 begins. Queuing process 400 starts at block 401. At decision block 402, queuing process 400 determines whether there are SUPL INIT messages in the Priority 1 queue, and if so, the following sub-steps are performed: the first SUPL INIT message in the Priority 1 queue is selected (block 404); and an attempt is made to implement the SUPL session with the SUPL INIT message in the queue (block 405). If at decision block 406 it is determined that the SUPL session was successfully established and completed, the Queues are flushed and the queuing process 400 returns to Start (block 401). If at decision block 406 it is determined that the SUPL session was not successfully established and completed, a try again function (block 407) may be utilized. If the try again function is utilized the SUPL INIT message may be attempted for use again in a SUPL session. If the try again function is not utilized, the last SUPL INIT message is flushed and queuing process 400 returns again to decision block 402, where it determined whether there is another SUPL INIT message in the Priority 1 queue. If there is another SUPL INIT message in the Priority 1 queue, the process again moves to block 404. If there are no SUPL INIT messages in the Priority 1 queue (decision block 402), the queuing process 400 moves to decision block 410.

At decision block 410, queuing process 400 determines whether there are SUPL INIT messages in the Priority 2 queue, and if so, the following sub-steps are performed: the first SUPL INIT message in the Priority 2 queue is selected (block 414); and an attempt is made to implement the SUPL session with the SUPL INIT message in the queue (block 415). If at decision block 416 it is determined that the SUPL session was successfully established and completed, the Queues are flushed and the queuing process 400 returns to Start (block 401). If at decision block 416 it is determined that the SUPL session was not successfully completed, a try again function (block 417) may be utilized. If the try again function is utilized the SUPL INIT message may be attempted for use again in a SUPL session. If the try again function is not utilized, the last SUPL INIT message is flushed and queuing process 400 returns again to decision block 410, where it determined whether there is another SUPL INIT message in the Priority 2 queue. If there is another SUPL INIT message in the Priority 2 queue, the process again moves to block 414. If there are no SUPL INIT messages in the Priority 2 queue (decision block 410), the queuing process 400 moves to decision block 420. It should be noted that at any time during the processing of the Priority queue 2 (block 414), that if SUPL INIT messages become available in the Priority 1 queue (e.g., as shown via Interrupt if SUPL INIT Message(s) are available in Priority 1 Queue (block 412)), then queuing process 400 moves to block 404 to process SUPL INIT messages in the Priority 1 queue. It should be noted that this may occur not only at block 414 but at blocks 410 and 415-417 as well.

At decision block 420, queuing process 400 determines whether there are SUPL INIT messages in the Priority 3 queue, and if so, the following sub-steps are performed: the first SUPL INIT message in the Priority 3 queue is selected (block 424); and an attempt is made to implement the SUPL session with the SUPL INIT message in the queue (block 425). If at decision block 426 it is determined that the SUPL session was successfully established and completed, the SUPL INIT message is flushed and the queuing process 400 returns again to decision block 420, where it determined whether there is another SUPL INIT message in the Priority 3 queue. If at decision block 426 it is determined that the SUPL session was not successfully established and completed, a try again function (block 427) may be utilized. If the try again function is utilized the SUPL INIT message may be attempted for use again in a SUPL session. If the try again function is not utilized, the last SUPL INIT message is flushed and queuing process 400 returns again to decision block 420, where it determined whether there is another SUPL INIT message in the Priority 3 queue. If there is another SUPL INIT message in the Priority 3 queue, the process again moves to block 424. However, if there are no SUPL INIT messages in the Priority 3 queue (decision block 420), the queuing process 400 returns to Start (block 401). It should be noted that at any time during the processing of the Priority queue 3 (block 424), that if SUPL INIT messages become available in the Priority 1 or Priority 2 queue (e.g., as shown via Interrupt if SUPL INIT Message(s) are available in Priority 1 or Priority 2 Queue (block 422)), then queuing process 400 moves to block 404 or block 414 to process SUPL INIT messages in the Priority 1 or Priority 2 queue (e.g., the Priority 1 queue always being given preference over the Priority 2 queue). It should be noted that this may occur not only at block 424 but at blocks 420 and 425-427 as well.

It should be noted that as to the optional try again functions 407, 417, and 427 that this allows for the option of trying the SUPL INIT message in a SUPL session even though it previously failed. The try again function may or may not be utilized and can be utilized based upon pre-defined characteristics. As an example, if an authentication succeeded and a secure session was established, and the E-SLP accepted the SUPL session, but the session failed due to a lost connection, the try again function may be utilized. Further, the try again functions may be utilized for a pre-set amount of N tries. As an example, with N=3, after 3 tries, the try again function will no longer be utilized for the SUPL INIT messages. This pre-set amount of tries features is completely selectable. Also, the try again function may be selected not to be utilized at all based upon particular pre-defined characteristics. For example, if there is an expired certificate in the certificate chain, then the try again function may not be utilized. As another example, if SUPL session was declined by the E-SLP due to an unexpected session ID, then the try again function may not be utilized. The try again function is an optional feature that may be governed by pre-defined characteristics for usage.

By utilizing this methodology, the SET mobile device 102 communicates with the correct E-SLP 128 as soon as possible, even if the E-SLP 128 used is a non-default FQDN format and/or not on a whitelist. Preferences are provided to those FQDN that are either on the E-SLP whitelist or are default FQDNs, and extra preferences are given when both apply. Further, a SUPL INIT message 130 may be used when the default FQDN format does not agree with an MNC/MCC used in the last X seconds. In this case, the SUPL INIT may be discarded or assigned to the Priority 2 queue. Additionally, the SET mobile device 102 may not stop an SUPL session in some cases (e.g., both non-default FQDN and not on the whitelist (“Priority 3” queue)). Further, these implementations can be fully implemented by an SET mobile device 102 without any changes SUPL architecture. Migration of E-SLP FQDN to default FQDN is allowed and migration to well supported uses of E-SLP whitelists is also allowed. Moreover, there are not adverse impacts to deployed SETs and E-SLPs.

It should be appreciated that aspects of the invention previously described may be implemented in conjunction with the execution of instructions by processors of the devices, as previously described. Particularly, circuitry of the devices, including but not limited to processors, may operate under the control of a program, routine, or the execution of instructions to execute methods or processes in accordance with embodiments of the invention. For example, such a program may be implemented in firmware or software (e.g. stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The techniques described herein can be used for various wireless communication systems such as Code Division Multiple Access (CDMA), Time division multiple access (TDMA), Frequency Division Multiple Access (FDMA), Orthogonal Frequency-Division Multiple Access (OFDMA), Single Carrier FDMA (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers Interim Standard (IS)-2000, IS-95 and IS-856 standards. A TDMA system can implement a radio technology such as Global System for Mobile Communications (GSM). An OFDMA system can implement a radio technology such as Evolved Universal Terrestrial Radio Access; (Evolved UTRA or E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDM®, etc. Universal Terrestrial Radio Access (UTRA) and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). Additionally, newer standards include 4G and Advanced LTE.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other suitable device. These devices may have different power and data requirements

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method to implement a queuing process by a position enabled mobile device to prioritize legitimacy of initiation messages comprising:
transmitting an emergency call;
receiving at least one initiation message; and
assigning the received initiation message to one of a plurality of priority queues, wherein assignment to the priority queue is based upon at least one of an identifier of an emergency location platform or a whitelist.

2. The method of claim 1, wherein the identifier of the emergency location platform is a domain name (DN).

3. The method of claim 1, wherein an acceptable code is a prior code used in a previous predetermined period of time.

4. The method of claim 2 wherein, if the DN is in a default format, is an acceptable code, and is in the whitelist, then the initiation message is assigned to a first priority queue.

5. The method of claim 2 wherein, if the DN is in a default format, is an acceptable code, and is not in the whitelist, then the initiation message is assigned to a second priority queue.

6. The method of claim 2 wherein, if the DN is in a default format, and is not an acceptable code, then the initiation message is discarded.

7. The method of claim 2 wherein, if the DN is in a default format, and is not an acceptable code, then the initiation message is assigned to a second priority queue.

8. The method of claim 2 wherein, if the DN is not in a default format, and is not in the whitelist, then the initiation message is assigned to a third priority queue.

9. The method of claim 1, wherein the plurality of priority queues include at least a first priority queue and a second priority queue.

10. The method of claim 9, further comprising a queuing process, wherein, during the queuing process, initiation messages in the first priority queue are utilized by the position enabled mobile device.

11. The method of claim 10, wherein, if initiation messages are not present in the first priority queue, then initiation messages in the second priority queue are utilized by the position enabled mobile device during the queuing process.

12. The method of claim 1 wherein the position enabled mobile device transmits the emergency call to a Public Safety Answering Point (PSAP) and the emergency location platform transmits a position estimate to the PSAP.

13. A mobile device comprising:
a network interface; and
a processor to execute operations including:
transmitting an emergency call;
receiving at least one initiation message; and
assigning the received initiation message to one of a plurality of priority queues, wherein assignment to the priority queue is based upon at least one of an identifier of an emergency location platform or a whitelist.

14. The mobile device of claim 13, wherein the identifier of the emergency location platform is a domain name (DN).

15. The mobile device of claim 13, wherein an acceptable code is a prior code used in a previous predetermined period of time.

16. The mobile device of claim 14 wherein, if the DN is in a default format, is an acceptable code, and is in the whitelist, then the initiation message is assigned to a first priority queue.

17. The mobile device of claim 14 wherein, if the DN is in a default format, is an acceptable code, and is not in the whitelist, then the initiation message is assigned to a second priority queue.

18. The mobile device of claim 14 wherein, if the DN is in a default format, and is not an acceptable code, then the initiation message is discarded.

19. The mobile device of claim 14 wherein, if the DN is in a default format, and is not an acceptable code, then the initiation message is assigned to a second priority queue.

20. The mobile device of claim 14 wherein, if the DN is not in a default format, and is not in the whitelist, then the initiation message is assigned to a third priority queue.

21. The mobile device of claim 13, wherein the plurality of priority queues include at least a first priority queue and a second priority queue.

22. The mobile device of claim 21, wherein the processor further executes a queuing process, wherein, during the queuing process, initiation messages in the first priority queue are utilized.

23. The mobile device of claim 22, wherein, if initiation messages are not present in the first priority queue, then initiation messages in the second priority queue are utilized.

24. The mobile device of claim 13 wherein the mobile device transmits the emergency call to a Public Safety Answering Point (PSAP) and the emergency location platform transmits a position estimate to the PSAP.

25. A mobile device comprising:
means for transmitting an emergency call;
means for receiving at least one initiation message; and
means for assigning the received initiation message to one of a plurality of priority queues, wherein assignment to the priority queue is based upon at least one of an identifier of an emergency location platform or a whitelist.

26. The mobile device of claim 25, wherein the identifier of the emergency location platform is a domain name (DN).

27. The mobile device of claim 25, wherein an acceptable code is a prior code used in a previous predetermined period of time.

28. The mobile device of claim 26 wherein, if the DN is in a default format, is an acceptable code, and is in the whitelist, then the initiation message is assigned to a first priority queue.

29. The mobile device of claim 26 wherein, if the DN is in a default format, is an acceptable code, and is not in the whitelist, then the initiation message is assigned to a second priority queue.

30. The mobile device of claim 26 wherein, if the DN is in a default format, and is not an acceptable code, then the initiation message is discarded.

31. The mobile device of claim 26 wherein, if the DN is in a default format, and is not an acceptable code, then the initiation message is assigned to a second priority queue.

32. The mobile device of claim 26 wherein, if the DN is not in a default format, and is not in the whitelist, then the initiation message is assigned to a third priority queue.

33. The mobile device of claim 25, wherein the plurality of priority queues include at least a first priority queue and a second priority queue.

34. The mobile device of claim 33, further comprising means for executing a queuing process, wherein, during the queuing process, initiation messages in the first priority queue are utilized.

35. The mobile device of claim 34, wherein, if initiation messages are not present in the first priority queue, then initiation messages in the second priority queue are utilized.

36. The mobile device of claim 25 wherein the mobile device transmits the emergency call to a Public Safety Answering Point (PSAP) and the emergency location platform transmits a position estimate to the PSAP.

37. A non-transitory computer-readable medium including code that, when executed by a processor, causes the processor to:
transmit an emergency call;
receive at least one initiation message; and
assign the received initiation message to one of a plurality of priority queues, wherein assignment to the priority queue is based upon at least one of an identifier of an emergency location platform or a whitelist.

38. The computer-readable medium of claim 37, wherein the identifier of the emergency location platform is a domain name (DN).

39. The computer-readable medium of claim 37, wherein an acceptable code is a prior code used in a previous predetermined period of time.

40. The computer-readable medium of claim 38 wherein, if the DN is in a default format, is an acceptable code, and is in the whitelist, then the initiation message is assigned to a first priority queue.

41. The computer-readable medium of claim 38 wherein, if the DN is in a default format, is an acceptable code, and is not in the whitelist, then the initiation message is assigned to a second priority queue.

42. The computer-readable medium of claim 38 wherein, if the DN is in a default format, and is not an acceptable code, then the initiation message is discarded.

43. The computer-readable medium of claim 38 wherein, if the DN is in a default format, and is not an acceptable code, then the initiation message is assigned to a second priority queue.

44. The computer-readable medium of claim 38 wherein, if the DN is not in a default format, and is not in the whitelist, then the initiation message is assigned to a third priority queue.

45. The computer-readable medium of claim 37, wherein the plurality of priority queues include at least a first priority queue and a second priority queue.

46. The computer-readable medium of claim 45, further comprising code for executing a queuing process, wherein, during the queuing process, initiation messages in the first priority queue are utilized.

47. The computer-readable medium of claim 46, wherein, if initiation messages are not present in the first priority queue, then initiation messages in the second priority queue are utilized.
